(19) United States
(12) Patent Application Publication
(10) Pub. No.: US 2006/0015300 A1
(43) Pub. Date: Jan. 19, 2006

(54) Method for generating a geometric offset form of an object

(76) Inventors: Walter Adrianus Gerardus Kleyweg, SR Berkel en Rodenrijs (NL); German Enrique Knoppers, NE Rotterdam (NL); Norbertus Marinus Johannes Petronella Kooijmans, VV Den Haag (NL); Jeroen Van Den Hout, HK Leiden (NL); Johannes Pieter Melio, EJ Best (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 10/505,018

(22) PCT Filed: Feb. 18, 2003
(86) PCT No.: PCT/NL03/00121

§ 371 Date: Aug. 24, 2005

(30) Foreign Application Priority Data
Feb. 18, 2002 (NL) 1019990

(51) Int. Cl. G06F 17/10

(52) U.S. Cl. 703/2

(57) ABSTRACT

A method for generating a digital geometric offset shape of an object based on a shape of the object according to an offset transformation including generating a digital geometric shape for describing the shape of the object, wherein the digital geometric shape comprises a plurality of basic figures, as in STL or NURBs. The invention further relates to a software program for carrying out the method according to the invention.

The invention relates to a method for generating a digital geometric offset shape of an object based on a shape of the object according to an offset transformation, the method comprising the following steps:

generating a digital geometric shape for describing the shape of the object, the digital geometric shape comprising a plurality of basic figures, as in Structural Triangulation Language (STL) or in Non-Uniform Rational Bezier-splines (NURBs);

generating a digital geometric offset shape based on the digital geometric shape.

The invention further relates to a software program which can be directly stored in the internal memory of a computer for carrying out a method according to the invention and, in particular, to a software program for generating a digital geometric offset shape of an object based on a shape of the object according to an offset transformation, the software program comprising a first module for processing a digital geometric shape for describing the shape of the object, the digital geometric shape comprising a plurality of basic figures, as in STL or in NURBs. In STL, a shape is described by triangular basic figures.

The method mentioned and the software program mentioned are known from practice and are used, for instance, for generating a digital (electronic) geometric offset shape for the production of spark electrodes. Spark electrodes are used in machining processes such as spark erosion processes. In a spark erosion process, a spark electrode is used for creating a mold cavity in a material. The thus created mold cavity in the material can, for instance, be used for making a mold. With the mold, according to an injection molding process, a product can be made in the mold cavity, while the shape of the product substantially corresponds to the shape of the spark electrode used.

The spark erosion process is a machining process according to which process a mold cavity is formed with a spark electrode by means of a machining action of sparks flashing over. The flashing over of sparks occurs as a result of an electric voltage difference which is applied between the spark electrode and the material in which the mold cavity is formed. During the spark erosion process, a space needs to be maintained between the spark electrode and the material to prevent short circuiting. This space is called the spark gap. As a result of the spark gap, the dimensions of the mold cavity formed during the spark erosion process are greater than the dimensions of the spark electrode. This should be taken into account during the manufacture of the spark electrode. The mold cavity, to be formed later with the spark electrode, call be intended for the manufacture of a product. In this case, on the basis of a given shape of the product to be fabricated, a digital geometric offset shape of the spark electrode is to be generated, while the dimensions of the spark gap are compensated for. As a rule, the shape of the product is given in a closed shape, such as a digital geometric shape, so that the geometric offset shape can be found by displacing the basic figures of the digital geometric shape of the object according to respective offset vectors from the respective base figures over a uniform offset distance, corresponding to the length of the offset vectors. The digital geometric shape can be fabricated with the aid of a CAD-package known per se. According to a known method, a digital geometric offset shape is then obtained, based on the digital geometric shape, by manually (not automatically) applying a uniform offset, optionally with the aid of the computer. With the thus found digital geometric offset shape, the spark electrode can be manufactured.

A first drawback of the known method for generating a digital geometric offset shape is that with this method, a uniform offset distance is utilized. The use of a spark electrode manufactured on the basis of a geometric offset shape with a uniform offset distance results in deviations in shape arising in the mold cavity during the spark erosion process, during the so-called orbital movement. The orbital movement is a movement whereby the spark electrode is moved in a circular motion about an orientation axis and whereby, locally, the spark gap is gradually reduced. The orbital movement is performed to obtain a better surface result. As a rule, the orbital movement consists of a combined circular movement about an orbital axis and a translation in the direction of the orbital axis. However, it is noted that various other orbital movements are possible. During the orbital movement with the spark electrode with a uniform offset distance, specifically too much material is removed at faces whose normal makes an angle with the orientation axis that is unequal to a whole multiple of 90 degrees.

A second drawback of the known method is that providing an offset in the geometric shape by hand is very time consuming.

It is an object of the invention to obviate at least one of the drawbacks mentioned. The method according to the invention is partly based on the insight that for some applications, a process corrected variable offset is to be utilized. This will be elucidated hereinbelow.

The object mentioned is achieved with the method according to the invention which is characterized in that it further comprises the following steps:

determining an offset vector for each basic figure, of the digital geometric shape, the offset vector being a function of the orientation of the respective basic figure in the digital geometric shape;

generating a temporary digital geometric offset shape based on the digital geometric shape, the temporary digital geometric offset shape. comprising a plurality of respective basic figures that correspond to the respective basic figures of the digital geometric shape, while each basic figure of the temporary digital geometric offset shape is displaced relative to the corresponding basic figure according to the associated offset vector of the digital geometric shape;

generating a digital geometric offset shape based on the temporary digital geometric offset shape, the digital geometric offset shape comprising a plurality of basic figures. Thus, a geometric offset shape is achieved whereby the offset distance of each basic figure depends on the orientation of this basic figure in the digital geometric shape. Accordingly, it is possible to use a process-controlled variable offset distance, whereby the offset distances are determined by the length of the offset vectors of the respective basic figure. As a rule, the basic figure will be a two-dimensional multiangular basic figure.

A further elaborated method according to the invention is characterized in that the method further comprises the following steps:

defining an orientation axis relative to the digital geometric shape;

determining an offset distance for each basic figure of the digital geometric shape, while the offset distance is a function of the angle between the respective basic figure of the digital geometric shape and the orientation axis;

generating the temporary digital geometric offset shape, whereby each basic figure of the temporary digital geometric offset shape has been displaced relative to the corresponding basic figure over the associated offset distance in the direction of the normal to the plane of the corresponding basic figure of the digital geometric shape. With this further elaborated method, for instance, a suitable geometric offset shape can be generated for the manufacture of a spark electrode, with the orientation axis preferably coinciding with the orbital axis. In particular, it is possible with this method to generate a geometric offset shape for a spark electrode which, when manufacturing a mold cavity, causes hardly any or no deviations in shape. Generating the digital geometric offset shape preferably takes place automatically.

A special variant of the further elaborated method according to the invention is characterized in that alpha α is an angle in degrees between the orientation axis and the normal to the plane of the respective basic figure of the digital geometric shape, and that the offset distance of the multiangular basic figure is equal to the products of a predetermined constant and the function value cos(45-|α|) for −90≦α≦90, and that the offset distance of the multiangular basic figure is equal to the product of a predetermined constant and the function values cos(−135+|α|) for −180≦α≦−90 or 90≦α≦180, wherein |α| is the absolute value of α. The predetermined constant is here determined by a basic offset distance for faces whose normal makes an angle with the orientation axis that is equal to a whole multiple of 90 degrees. The faces whose normal makes an angle with the orientation axis that is unequal to a whole multiple of 90 degrees obtain an increased offset distance relative to the basic offset distance, thereby preventing too much material being removed at these faces.

An embodiment of the method according to the invention is characterized in that the multiangular basic figures mentioned are triangles, as in STL, and that the method further comprises the following steps:

determining at least one set with at least one point of reference, the at least one point of reference being determined by at least a combination of three surfaces, each surface of the at least one combination of three surfaces being a surface of a basic figure of a first subset of basic figures of the temporary digital geometric offset shape, while the first subset of basic figures corresponds to a second subset of basic figures of the digital geometric shape, the second subset of basic figures having a common angular point;

determining an angular point of a basic figure of the digital geometric offset shape for each common angular point of the second subset with the aid of the set with at least one reference point.

With this embodiment, a solution is presented to the problem that arises when giving offset distances to surfaces of the geometric offset shape. Thus, in particular, a solution is provided for determining in what manner roundings change and how intersecting lines between displaced surfaces are to be trimmed again. Simply displacing surfaces is not possible in all cases as there are situations where surfaces of the geometric shape have a common angular point, but where these surfaces, after displacement with the offset distances, no longer have a common intersection. In such cases, for all combinations of three offset surfaces that correspond to surfaces of the second subset, reference points are determined, whereupon, on the basis of the reference points, a new common angular point is determined. Optionally, when determining the angular point, use can be made of the normal vectors of the offset surfaces. On the basis of the normal vectors of the combination of three surfaces it is then determined whether these surfaces are convergent or divergent. If the three surfaces are divergent, the reference point found here is not used for determining the angular point of the geometric offset shape if the reference point is removed at a greater distance than the basic offset distance of the respective angular point of the geometric shape. Further, it holds that if the three surfaces are convergent, the reference point is not used for determining the angular point of the geometric offset shape if the reference point is at a smaller distance from the respective angular point of the geometric shape than the basic offset distance. In the case of a combination of convergent and divergent surfaces of the basic figures, an angular point is determined depending on the normal vectors of the surfaces of the second subset.

The method according to the invention can be carried out with the aid of a CAD-system for generating, for instance, a first STL-file or NURB-file having the digital geometric shape, while a software algorithm can be utilized for generating, for instance, a second STL-file or NURB-file having the digital geometric offset shape. The software program for generating the digital geometric offset shape of the object based on a shape of the object according to the invention is characterized in that the software program comprises a module for determining an offset vector for each basic figure of the digital geometric shape, while the offset vector is a function of the orientation of the respective basic figure in the digital geometric shape, the software program further comprising a module for generating a temporary digital geometric offset shape based on the geometric shape, while the temporary digital geometric offset shape comprises a plurality of respective basic figures which correspond to the respective basic figures of the digital geometric shape, while each basic figure of the temporary digital geometric offset shape is displaced relative to the corresponding basic figure of the digital geometric shape according to the associating offset vector.

The invention will presently be further elucidated with reference to the drawing. In the drawing:

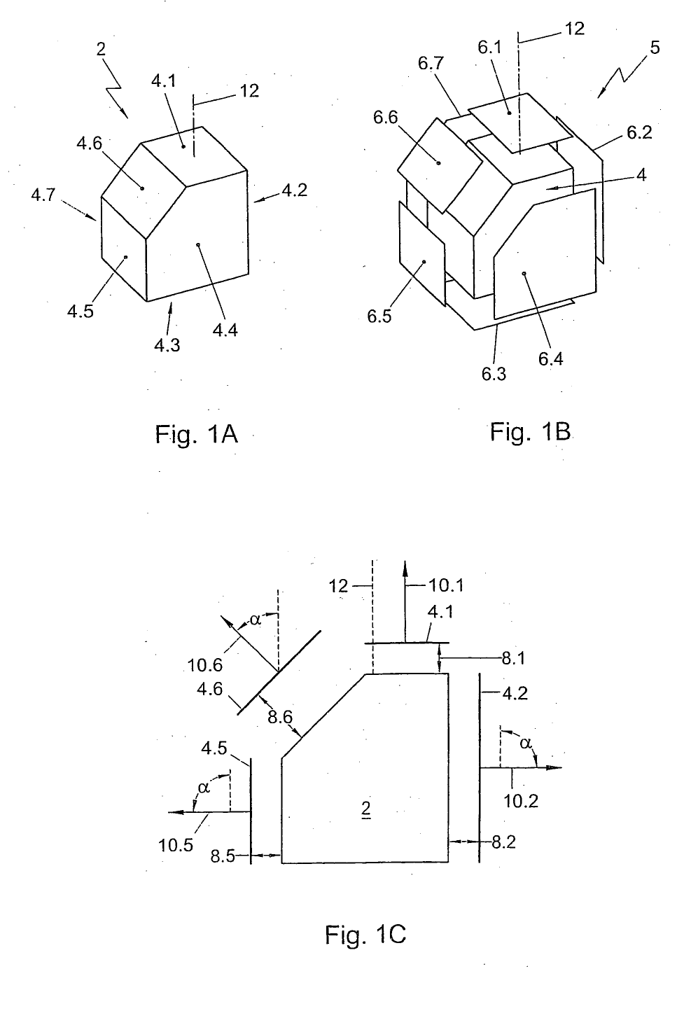

FIG. 1A schematically shows a geometric shape of a first object, the geometric shape comprising a plurality of two-dimensional multiangular basic figures;

FIG. 1B schematically shows a geometric shape according to FIG. 1A and a temporary geometric offset shape formed on the basis thereof;

FIG. 1C is a cross section of FIG. 1B;

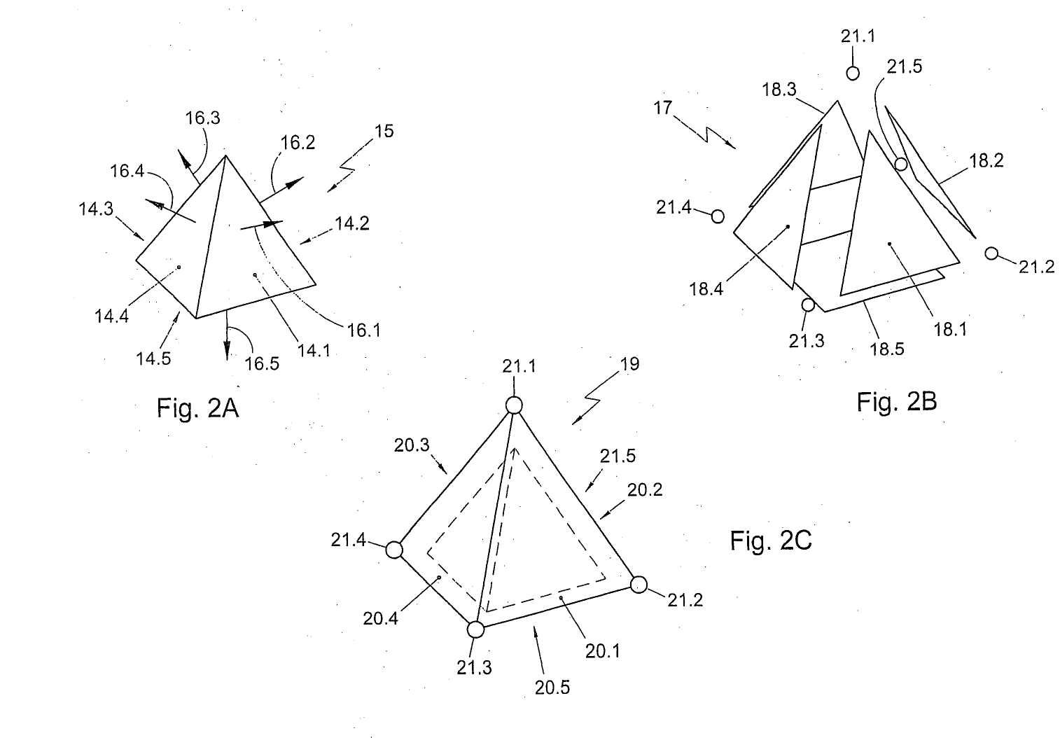

FIG. 2A schematically shows a geometric shape of a second object, the geometric shape comprising a plurality of two-dimensional triangular basic figures;

FIG. 2B schematically shows a temporary geometric offset shape formed on the basis of the geometric shape of FIG. 2A;

FIG. 2C schematically shows the geometric shape of FIG. 2A and the geometric offset shape of FIG. 2B formed on the basis thereof;

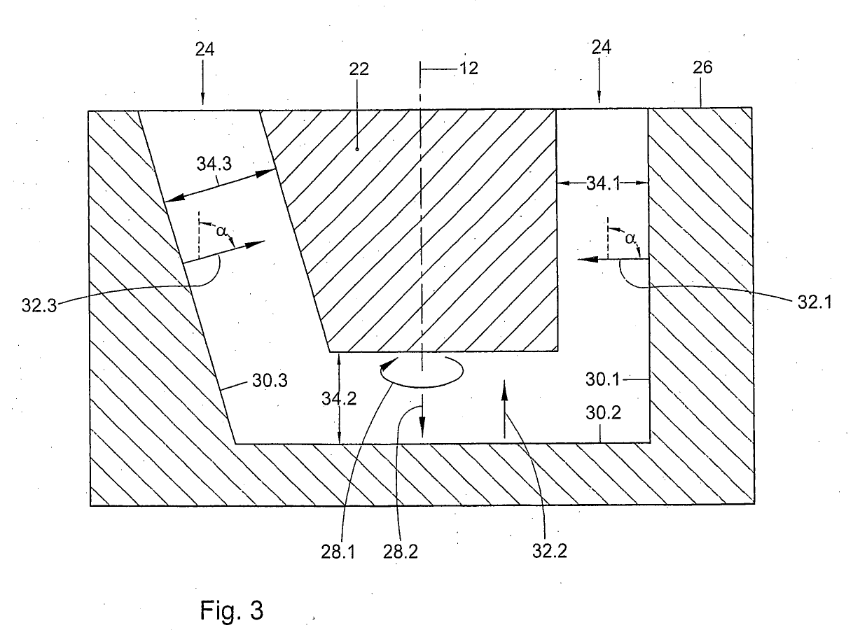

FIG. 3 is an illustration of a spark erosion process, wherein with the aid of a spark electrode, a mold cavity is formed in a material.

FIGS. 1A, 1B and 1C illustrate a part of the method according to the invention for generating by computer a digital geometric offset shape of an object. With the method, a geometric offset shape comprising a plurality of two-dimensional, multiangular basic figures can be formed based on a geometric shape 2 which likewise consists of a plurality of two-dimensional multiangular basic FIGS. 4.1, . . . , 4.7. However, in a corresponding manner, use can also be made of, for instance, NURBs. In FIGS. 1A, 1B and 1C, it is illustrated in particular how a temporary geometric offset shape 5 is formed based on the geometric shape 2. The geometric shape 2 is a description of a shape of an object. FIG. 1B shows a temporary geometric offset shape, wherein the respective multiangular basic FIGS. 4.1, . . . , 4.7 of the geometric shape 2 have been displaced over respective offset distances relative to the basic FIGS. 4.1, . . . , 4.7 of the geometric shape 2. In the offset transformation, the basic FIG. 4.i (i=1, . . . , 7) is displaced over an offset distance (corresponding to the length of the respective offset vector) in the direction of the normal to the plane of the basic FIG. 4.1, over the offset distance for obtaining the basic FIG. 6.i (i=1, . . . , 7) of the temporary geometric offset shape.

For each basic FIG. 4.i, the magnitude of the offset distance 8.2 depends on the offset vector 10.i (the normal 10.i) of the respective plane of the basic FIG. 4.i and the direction of the orientation axis 12. This is further illustrated in FIG. 1C in which a two-dimensional cross section is presented of FIG. 1B. In FIG. 1C, it is to be seen, for instance, that the angle of the offset vector 10.1 of the plane of the basic FIG. 4.1 and the orientation axis 12 is zero degrees FIG. 1C further shows, for instance, that the angle between, for instance, the offset vector 10.2 of the plane of the basic FIG. 4.2 and the orientation axis 12 is ninety degrees. It can also be seen that the offset distance 8.1 is smaller than the offset distance 8.6 (as in agreement with the respective lengths of the offset vectors 10.1 and 10.6).

The two-dimensional figures shown in FIGS. 1B and 1C are quadrangular and pentangular. In FIGS. 2A, 2B and 2C, the two-dimensional basic figures shown are triangular. In particular in so-called CAD-packages, use is made of such triangular basic figures. Here, geometric shapes are described with the aid of STL (STL) files. In FIG. 2A, with the aid of five triangular basic FIGS. 14.1, 14.2, 14.3, 14.4 and 14,5, a geometric shape 15 of a pyramid is described. With each triangular basic figure, the associated offset vector 16.i is given which is perpendicular to the plane of the basic FIG. 14.j (j=1, . . . , 5)

In FIG. 2B, a temporary geometric offset shape 17 of the geometric shape 15 of the pyramid of FIG. 2A is shown. This temporary geometric offset shape 17 is obtained by displacing the triangular basic FIG. 14.j (i=1, . . . , 5) of the pyramid of FIG. 2a over respective offset distances according to the respective lengths of the offset vectors 16.i (in the direction of the outwardly directed normals) from the planes of the basic FIG. 14.i (i=1, . . . , 5). As shown in FIG. 2B, the basic FIG. 18.j (j=1, . . . . , 5) of the temporary geometric offset shape 17 do not adjoin each other. It is the intention now, on the basis of the temporary geometric offset shape 17, to achieve a geometric offset shape 19 whose basic FIG. 20j (j=1, . . . , 5) do link up, so that a closed geometric shape is obtained. For this purpose, a set with at least one reference point is determined, while the at least one reference point is determined by at least one combination of three surfaces, while each surface of the at least one combination of three surfaces is a surface of a triangle of a first subset of triangles of the temporary geometric offset shape. Further, the first subset of triangles is to correspond to a second subset of triangles of the geometric shape the second subset of triangles having a common angular point. Concretely, this means for the FIGS. 2A, 2B and 2C that five sets are obtained by each time intersecting three of four surfaces of the first subset. In this case, each set has one reference point 21.j (j=1, . . . . , 5). On the basis of the reference points 21.j (j=1, . . . , 5) the angular points of the geometric offset shape 19 are determined (see FIG. 2C).

For the pyramid of FIG. 2A, the angular points of the geometric offset shape 19 can be found in a uniform manner on the basis of the reference points 21.j (j=1, . . . . , 5). However, this is not the case with, for instance, a conic section built up from triangular basic figures. In such a case, several reference points, which are related to a common angular point of the geometric shape can be found located closely together in a cloud. In that case, it is not clear in advance where the new angular point of the geometric offset shape is to lie. In this case, the new common angular point is determined on the basis of normal vectors of surfaces of the respective basic figures of the temporary geometric offset shape. Here, on the basis of the normal vectors of the surfaces of the combination of three surfaces of the first subset, it is determined whether these planes are convergent or divergent. If the three surfaces are divergent, the reference point found here is not used for determining the angular point of the geometric offset shape if the reference point is removed a distance greater than the basic offset distance from the respective angular point of the geometric shape. Further, if the three surfaces are convergent, it holds that the reference point is not used for determining the angular point of the geometric offset shape if the reference point is at a smaller distance from the respective angular point of the geometric shape than the basic offset distance. In the case of a combination of converging and diverging surfaces of the basic figures, an angular point is determined depending on the normal vectors of the surfaces of the second subset.

FIG. 3 schematically illustrates a method with which, with the aid of a spark electrode 22, a mold cavity 24 is formed in a material 26. The mold cavity 24 in the material 26 can later be used, for instance as a mold, for manufacturing products by an injection molding process, whereby the product to be obtained has substantially the same shape as the spark electrode 22. In FIG. 3, an orientation axis is given which corresponds to the so-called orbital axis of the spark electrode 22. During spark machining, the spark electrode 22 is moved according to an orbital movement, schematically indicated with the movement arrows 28.1 and 28.2, circularly and longitudinally in the direction of the orbital axis 10 in the mold cavity 24. The object here is to reduce the spark gap, the space between the spark electrode 22 and the material 26, in different directions for finishing the walls of the mold cavity 24. By doing so, these walls are stripped of irregularities as much as possible. In FIG. 3, schematically, three walls 30.1, 30.2 and 30.3 of the mold cavity 24 are given. In this example, each of these walls is substantially planar. The orientation of the wall 30.k is provided by the angle a between the orientation axis 12 and the normal 32.k (k=1, 2, 3).

In FIG. 3, a number of dimensions of the spark gap between the spark electrode and the respective surfaces 30.i are schematically indicated with arrows 34.k (k=1, 2, 3). From FIG. 3, it appears that at different surfaces, different dimensions of the spark gap are involved, depending on the angle α. The dimension 34.3, for instance, is greater than the dimension 34.1 or 34.2. What is prevented with this variable dimension of the spark gap is that during orbiting, too much material is removed when the material is spark-machined. What is prevented in particular is that, when the spark electrode 22 is moved downwards according to the arrow 28, during the circular movement,. schematically indicated by the arrow 28.1, too much material is machined from the wall surface 30.3. In this example, the process-controlled spark gap size is given as function of the angle α by the product of a predetermined constant and the function value cos(45-|α|) for −90≦α≦90, and by the product of a predetermined constant and the function value cos(−135+|α|) for −180≦α≦−90 or 90≦α≦180, wherein |α| is the absolute value of α, and wherein the angle α is the angle between the normal to the plane of the mold cavity 24 and the orientation axis 12 in degrees. The predetermined constant can be a predetermined basic offset value.

According to an alternative mathematical function, the spark gap size is given by the product of a predetermined constant and the function value (1+|sin(2α)|·(√2−1)). The predetermined constant can be a predetermined basic offset value.

In connection with the spark gap 24, the dimensions of the spark electrode 22 are smaller than the dimensions of the mold cavity 24. This has as a consequence that in the manufacture of the spark electrode 22, in advance the dimensions of the spark gap are to be taken into account. Often, a STL-file is available with a geometric shape of the mold cavity 24 of a mold. Then, on the basis of this geometric shape, a suitable geometric shape of the spark electrode 22 should be generated, taking the dimensions of the spark gap into account. A geometric offset shape is created describing the shape of the spark electrode, which geometric offset shape is obtained by an offset transformation of the shape of the mold cavity 24. The offset transformation can be particularly complicated when the mold cavity 24 consists of many surfaces making different angles with the orbital axis 10 or orientation axis 12. The offset transformation can be carried out by a software program for generating a geometric offset shape, according to the method of the invention. To this end, the software program comprises a first module for generating a geometric shape for describing the mold cavity 24, this geometric shape comprising a plurality of multiangular basic figures, as in STL. Further, the software program comprises a second module for determining an offset distance for each basic figure of the geometric shape, the offset distance being a function of an angle between a normal to the plane of the basic figure and a predetermined orbital axis or orientation axis of the geometric shape, while the software program further comprises a third module for generating a temporary geometric offset shape based on the geometric shape. Each multiangular basic figure is then displaced over an offset distance in the direction of the normal to the plane of the multiangular basic figure. The software program furthermore comprises a fourth module for generating a geometric offset shape based on a temporary geometric offset shape, the geometric offset shape comprising a plurality of multiangular basic figures.

The invention has been described with reference to a few exemplary embodiments and is not limited in any way to these exemplary embodiments. Diverse variations on these exemplary embodiments falling within the framework of the invention are conceivable.

1-15. (canceled)

16. A method for generating a digital geometric offset shape of an object on the basis of a shape of the object according to an offset transformation, the method comprising the steps of:
generating a digital geometric shape for describing the shape of the object, the digital geometric shape comprising a plurality of basic figures, wherein said basic figures are two-dimensional multiangular basic figures;
generating a digital geometric offset shape based on the digital geometric shape;
determining an offset vector for each basic figure of the digital geometric shape, wherein the offset vector is a function of the orientation of the respective basic figure in the digital geometric shape;
generating a temporary digital geometric offset shape based on the digital geometric shape, the temporary digital geometric shape comprising a plurality of respective basic figures corresponding to the respective basic figures of the digital geometric shape, whereby each basic figure of the temporary digital geometric offset shape is displaced relative to the corresponding basic figure of the digital geometric shape according to the associated offset vector; and
generating a digital geometric offset shape based on the temporary digital geometric offset shape, wherein the digital geometric offset shape comprises a plurality of basic figures.

17. A method according to claim 16, wherein said two-dimensional multiangular basic figures are triangular.

18. A method according to claim 16, further comprising the steps of:
defining an orientation axis relative to the digital geometric shape;
determining an offset distance for each basic figure of the digital geometric offset shape, wherein the offset distance is a function of the angle between the respective basic figure of the digital geometric shape and the orientation axis; and
generating the temporary digital geometric offset shape, whereby each basic figure of the temporary digital geometric offset shape has been displaced over the associated offset distance in the direction of the normal to the plane of the corresponding basic figure of the digital geometric shape relative to the corresponding basic figure.

19. A method according to claim 18, wherein a is an angle in degrees between the orientation axis and the normal to the plane of the respective basic figure of the digital geometric shape, and wherein the offset distance of the multiangular basic figure is equal to the product of a predetermined constant and the function value cos(45−|α|) for −90≦α≦90, and wherein the offset distance of the multiangular basic figure is equal to the product of a predetermined constant and the function value cos(−135+|α|) for one of −180≦α≦−90 and 90≦α≦180, wherein |α| is the absolute value of α.

20. A method according to claim 18, wherein a is an angle in degrees between the orientation axis and the normal to the plane of the respective basic figure of the digital geometric shape, and wherein the offset distance of the multiangular basic figure is equal to the product of a predetermined constant and the function value (1+|sin(2·α)|·(√2−1)).

21. A method according to claim 16, wherein said basic figures are triangles, and wherein the method further comprises the steps of:
determining at least one set with at least one reference point, wherein the at least one reference point is determined by at least one combination of three surfaces, wherein each surface of the at least one combination of three surfaces is a surface of a basic figure of a first subset of basic figures of the temporary digital geometric offset shape, wherein the first subset of basic figures corresponds to a second subset of basic figures of the digital geometric shape, and the second subset of basic figures has a common angular point; and
determining, with the aid of the set with at least one reference point, for each common angular point of the second subset, an angular point of a basic figure of the digital geometric offset shape.

22. A method according to claim 21, wherein the method further comprises the steps of:
generating a direction vector for at least one common angular point of the second subset, wherein the direction vector is a weighted average of the normal vectors to the planes of the basic figure of the second subset; and
determining for the common angular point of the second subset an angular point of a basic figure of the digital geometric offset shape with the aid of the set with at least one reference point and the direction vector.

23. A method according to claim 21, wherein the angular points of the digital geometric offset shape are partly determined on the basis of the distances of the respective directional points relative to the angular point of the respective subset.

24. A method according to claim 21, wherein for a set with more than one reference point, the respective angular point of the respective basic figure of the geometric offset shape is determined to be the angular point corresponding to the reference point nearest to said common angular point of the second subset.

25. A method according to claim 16, wherein the method is carried out with the aid of a CAD-system for generating a first STL-file with the digital geometric shape, and that use is made of a software algorithm for generating a second STL-file with the digital geometric offset shape.

26. A method according to claim 16, wherein a digital geometric offset shape for a spark electrode for spark machining operations is generated, wherein the spark electrode is manufactured in accordance with the digital geometric offset shape.

27. A software program that can be loaded directly into the internal memory of a digital computer, comprising software code configured to run on a computer for generating a digital geometric offset shape of an object on the basis of the shape of the object according to an offset transformation comprising the steps of:
generating a digital geometric shape for describing the shape of the object, the digital geometric shape comprising a plurality of basic figures, wherein said basic figures are two-dimensional multiangular basic figures;
generating a digital geometric offset shape based on the digital geometric shape;
determining an offset vector for each basic figure of the digital geometric shape, wherein the offset vector is a function of the orientation of the respective basic figure in the digital geometric shape;
generating a temporary digital geometric offset shape based on the digital geometric shape, the temporary digital geometric shape comprising a plurality of respective basic figures corresponding to the respective basic figures of the digital geometric shape, whereby each basic figure of the temporary digital geometric offset shape is displaced relative to the corresponding basic figure of the digital geometric shape according to the associated offset vector; and
generating a digital geometric offset shape based on the temporary digital geometric offset shape, wherein the digital geometric offset shape comprises a plurality of basic figures.

28. A software program stored directly in the internal memory of a digital computer for generating a digital geometric offset shape of an object based on a shape of the object according to an offset transformation, wherein the software program comprises:
a first module for processing a digital geometric shape for describing the shape of the object, the digital geometric shape comprising a plurality of basic figures;
a second module for determining an offset vector for each basic figure of the digital geometric shape, wherein the offset vector is a function of the orientation of the respective basic figure in the digital geometric shape; and
a third module for generating a temporary digital geometric offset shape based on the digital geometric shape, the temporary digital geometric offset shape comprising a plurality of respective basic figures corresponding to the respective basic figures of the digital geometric shape, whereby each basic figure of the temporary digital geometric shape is displaced relative to the corresponding basic figure of the digital geometric shape according to the associated offset vector.

29. A software program according to claim 28, wherein the software program furthermore comprises a fourth module for generating a digital geometric offset shape based on the temporary digital geometric offset shape, wherein the digital geometric offset shape comprises a plurality of basic figures.

30. A method according to claim 16, wherein a plurality of basic figures is one of STL figures and NURB figures.
